(19) United States
(12) Patent Application Publication
(10) Pub. No.: US 2009/0200286 A1
(43) Pub. Date: Aug. 13, 2009

(54) METALLIC SHEATHED-ELEMENT GLOW PLUG INCLUDING TEMPERATURE MEASUREMENT

(76) Inventor: Andreas REISSNER, Stuttgart (DE)

Correspondence Address: KENYON & KENYON LLP, ONE BROADWAY, NEW YORK, NY, 10004, US

(21) Appl. No.: 12/365,713

(22) Filed: Feb. 4, 2009

(30) Foreign Application Priority Data
Feb. 7, 2008 (DE) 102008008205.8

(51) Int. Cl. F23Q 7/22; G01K 7/16

(52) U.S. Cl. 219/264; 374/185; 374/E07.018

(57) ABSTRACT

A sheathed-element glow plug, in particular for starting a self-igniting internal combustion engine, including a glow element having a tip that projects into a combustion chamber of the internal combustion engine, the glow element including a glow tube. Disposed inside the glow tube is a glow filament, which has a specific electric cold resistance in the range of between 0.2 to 1.0 μΩm, the specific electric resistance increasing as the temperature rises. Furthermore, a device for detecting the temperature of a sheathed-element glow plug and a method for detecting the temperature of a sheathed-element glow plug, the resistance of the glow filament during operation being detected and the temperature at the tip of the glow tube being determined from the resistance.

### FIELD OF THE INVENTION

The present invention relates to a sheathed-element glow plug, in particular for starting a self-igniting internal combustion engine. Furthermore, the present invention relates to a device for detecting the temperature of a sheathed-element glow plug, and to a method for detecting the temperature of a sheathed-element glow plug, in particular for starting a self-igniting internal combustion engine.

### BACKGROUND INFORMATION

At low temperatures, a self-igniting internal combustion engine requires an ignition aid. For this, sheathed-element glow plugs are used, which are installed in the cylinder head and project into the combustion chamber. The sheathed-element glow plugs are equipped with a glow element, which offers the fuel-air mixture to be ignited a hot spot at which the fuel-air mixture is able to ignite.

Currently, sheathed-element glow plugs which reach their nominal temperature at a supply voltage that lies below the available on-board voltage, in general in the range between 7 V and 12 V, are often used. The supply voltage of the sheathed-element glow plug is also referred to as nominal voltage and generally lies within a range of between 4V and 7V. The advantage of these sheathed-element glow plugs is their brief heating time and the possibility of adapting the temperature to the different engine states. Because of the low nominal voltage, the full nominal voltage is available even when the on-board voltage of the vehicle drops to 7V during the startup of the internal combustion engine. These sheathed-element glow plugs are known as rapid-start spark plugs or low-voltage spark plugs.

The application of the voltage causes a current to flow through the heating element implemented as electrical resistor, which heats the glow element to a defined temperature. This temperature is selected such that it is sufficiently high to ignite the fuel-air mixture inside the combustion chamber of the internal combustion engine. The temperature of the glow element results from the applied voltage, and the cooling of the glow element results from the running engine. Depending on the engine state, the temperature is adjustable by the level of the applied voltage. To ensure that the glow element has the correct temperature during the engine start and the warm-up phase, the glow system encompassing the sheathed-element glow plug, control device and software must be adapted. Special temperature-measuring plugs having an installed thermo element are available solely for this purpose, which must be produced by hand in a cost-intensive manner.

The heating element is usually implemented as dual-component resistor element. In this context a heating element and a control element are connected in series. The heating element is usually made of a typical heat-conducting material, e.g., an FeCrAl alloy having a correspondingly high specific electric resistance and a very low electric temperature coefficient. In contrast, the control element has a very low specific electric resistance at room temperature. In exchange, the temperature coefficient of the control element is very high. A typical material used for the control element is nickel, for example, which at a temperature of 1000° C. exhibits a specific electric resistance that is approximately six times higher than at room temperature.

The electric resistance of the sheathed-element glow plug is able to be kept low at room temperature and below because of the control coil. The electric resistance is higher during operation. This compensates for tolerances, and the nominal voltage is increased. For very rapid heating, these sheathed-element glow plugs known from the related art are operated at a voltage of up to 11 V_{eff} for a brief period of time. The voltage must then be adjusted such that the desired temperature of the sheathed-element glow plug is maintained and it does not overheat at the same time.

In sheathed-element glow plugs for temperature measurement, thermo wires are usually welded into the tip of the glow tube with the filament. The wires are routed to the outside through the hollow connecting bolt. From DE German Patent No. 9112242, a metallic sheathed-element glow plug is known, in which a surface thermo element is embedded laterally inside a groove.

### SUMMARY OF THE INVENTION

A sheathed-element glow plug designed according to the present invention, in particular for starting a self-igniting internal combustion engine, includes a glow element having a tip that projects into a combustion chamber of the internal combustion engine. The glow element includes a glow tube inside which a glow filament is disposed, which has a specific electric resistance in the range of 0.2 to 1.0 μΩm, the specific electric resistance increasing with rising temperature.

The use of a glow filament having a specific electric resistance in the range of 0.2 to 1.0 μΩm at room temperature, the specific electric resistance rising with increasing temperature, makes it possible to dispense with the control coil known from the related art.

In general, the following applies to the specific electric resistance of the glow filament

p(T)=pₒ·(1+α·(T−T₀)). (1)

In equation (1), p(T) is the specific resistance as a function of temperature T, p₀ is the specific cold resistance at a specific temperature T₀ and α=m/p₀ with a rise m>0.2 μΩm/° C. in the range between 800° C. and 1200° C.

Rise m preferably lies in a range between 0.25 and 2.0 μΩm/° C. Temperature T₀ at which specific cold resistance p₀ is determined is 20° C. as a rule.

In addition, the present invention relates to a device for detecting the temperature of a sheathed-element glow plug, the glow filament of the sheathed-element glow plug being connected to means for control by which the resistance of the glow filament during operation is able to be detected. To determine the temperature, the resistance of the glow filament during operation is detected, and the temperature at the tip of the glow tube is ascertained from the resistance.

Detecting the temperature of the sheathed-element glow plug makes it possible to adjust the temperature of the sheathed-element glow plug. Overheating of the sheathed-element glow plug, for example, is able to be avoided in this manner. Overheating of the sheathed-element glow plug may cause the sheathed-element glow plug to melt and parts of it to drop into the combustion chamber. This results in engine damage. In addition, the temperature monitoring and the attendant temperature control prevent that sporadically occurring errors that may result in connection with all electric vehicle components and are often very difficult to trace, lead to overheating of the sheathed-element glow plug. In addition, combinations of vehicle states may lead to a deviating temperature of the sheathed-element glow plug. Exhaust-gas recirculation, regeneration of the particulate filter, charge pressure, load, aspirated air temperature, ambient pressure etc. affect the temperature of the sheathed-element glow plug. It is becoming more and more difficult to check all of the combinations that occur in an application. In this context it is very advantageous if the glow system maintains the temperature at the setpoint autonomously. This will then cover all not envisioned influences and their combinations.

In order to be able to record the temperature of the sheathed-element glow plug as precisely as possible, it is preferred if the glow filament is positioned in a region 5 to 15 mm from the tip of the glow element. Furthermore, it is preferred if the temperature gradient between the glow filament and the surface of the glow tube is kept as low as possible. To this end, the clearance between the glow filament and the inner side of the glow tube preferably amounts to at least 0.2 mm. It is especially preferred if the clearance between the glow filament and the inner side of the glow tube lies within the range of 0.2 and 0.6 mm.

The temperature measurement is implemented via the detection of the resistance of the sheathed-element glow plug during operation. To this end the glow filament is connected to a device for detecting the resistance of the glow filament. The device for detecting the resistance usually is integrated in the means for control. Furthermore, the means for control are designed such that the temperature is ascertainable from the resistance of the glow filament. The means for control may be a glow control device, for example. However, it is also possible to shift at least parts of the control to the engine control device. In this case the glow system includes the glow control device and a software module in the engine control device.

The means for control preferably also include a temperature controller. In this case the required temperature to be attained by the sheathed-element glow plug is generally transmitted by the engine control device and then adjusted by the means for control. The means for control are also able to intercept impermissible setpoint temperatures, which are transmitted by the engine control device as the case may be. Instead of the impermissible setpoint temperatures, the permitted maximum temperature is then adjusted for the sheathed-element glow plug.

To be able to compensate for manufacturing fluctuations of the sheathed-element glow plugs, it is preferred to detect the cold resistance of the glow filament by the means for control so as to calibrate the sheathed-element glow plug. This is advantageous in particular because the cold resistance according to equation (1) enters into the determination of the temperature from the specific resistance. The cold resistance may also change due to aging of the materials. In that case it is advantageous if a recalibration is undertaken at regular intervals.

To prevent damage to the sheathed-element glow plug as a result of an exceedance of a maximally tolerated temperature, in one specific embodiment it is preferred if the sheathed-element glow plug is switched off when the maximally tolerated temperature is exceeded. This is likewise generally achieved by the means for control.

Suitable materials for the glow filament are, for example, NiFe compounds, in particular NiFe30, FeNiCo compounds. Also suitable are high and low alloy steels.

As an alternative, it is also possible to use a series connection of one heating coil and one control coil, provided the control coil component is situated inside the heating coil and as far in the front as possible inside the glow tube tip. In this case, control coil components and heating coil components are switched in alternation. To make it possible to detect the temperature from the resistance of the sheathed-element glow plug, even in a series connection of heating coil and control coil it is necessary for the coil to be implemented correspondingly short, i.e., situated in a region between 5 and 15 mm of the tip of the sheathed-element glow plug.

### BRIEF DESCRIPTION OF THE DRAWINGS

FIG. 1 shows a sheathed-element glow plug having a heating coil and a control coil, as it is known from the related art.

FIG. 2 shows a schematic illustration of a sheathed-element glow plug designed according to the present invention.

### DETAILED DESCRIPTION

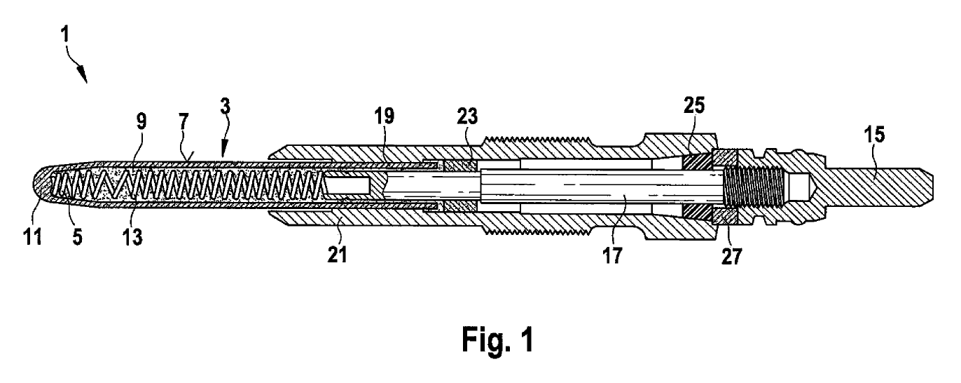

FIG. 1 shows a sheathed-element glow plug as it is known from the related art.

A sheathed-element glow plug 1 includes a glow tube 3 inside which a heating coil 5 is accommodated. Glow tube 3 is usually made of a metal that is resistant to high temperatures. Suitable metallic materials for glow tube 3 are, for example, NiCr23Fe and NiCr25FeAlY.

A typical heat-conducting material such as an FeCrA1 alloy, for example, having high specific electric resistance and a very low electric temperature coefficient is generally used for heating coil 5. The very low electric temperature coefficient causes the very high specific electric resistance of heating coil 5 to change only negligibly during the heating-up process. Heating coil 5 is heated by application of a voltage. To transmit the heat from heating coil 5 to surface 7 of glow tube 3, glow tube 3 is filled with a filler 9. A temperature-resistant filler powder having excellent thermal conductivity is normally used as filler 9. Magnesium oxide, for example, is a suitable material for the filler powder.

For contacting, heating coil S is connected to top 11 of glow tube 3 on the ground side. The connection of heating coil 5 to top 11 of glow tube 3 is typically implemented by welding.

In the sheathed-element glow plugs known from the related art, heating coil 5 is connected in series with a control coil 13. In contrast to heating coil 5, control coil 13 has very low specific electric resistance at room temperature and a high positive temperature coefficient. This means that the resistance of control coil 13 increases as the temperature rises. A material normally used for control coil 13 is nickel, for example, which at a temperature of 1000° C. has a specific electric resistance that is approximately six times higher than at room temperature. In addition to nickel, CoFe, in particular CoFe8, for example, is a suitable material for control coil 13.

When applying a voltage to sheathed-element glow plug 1, first the largest part of the electrical energy is converted into heat inside heating coil 5. This causes the temperature to rise considerably at the tip of sheathed-element glow plug 1, i.e., in the region of heating coil 5. The temperature of control coil 13 increases with a time delay. Because of this time delay, the resistance likewise increases with the corresponding time delay. Because of the increase in resistance, the current consumption is reduced and the total output of sheathed-element glow plug 1 drops. The temperature approaches a steady condition. This avoids further heating of the sheathed-element glow plug and its bum-through. However, as a result of aging, sheathed-element glow plugs 1 known from the related art no longer heat to their maximum temperature over the course of their service life. This may have a detrimental effect on the starting characteristics and the warm-up phase of the engine. To prevent overheating of sheathed-element glow plug 1, all driving states must be checked very carefully in the application of the glow system. Measuring-sheathed-element glow plugs are normally produced for this purpose, by hand in a time- and labor-intensive manner. Their production is expensive and they have only a short service life. The sheathed-element glow plug known from the related art does not allow monitoring of the temperature of sheathed-element glow plug 1

The voltage supply of sheathed-element glow plug 1 generally is implemented via a circular plug 15. Circular plug 15 is connected to a connecting bolt 17, which in turn contacts control coil 13. Connecting bolt 17 as well as an upper end 19 of glow tube 3 facing away from top 11 of glow tube 3 are accommodated inside a housing 21. A heating element seal 23 is situated adjacent to glow tube 3. Heating element seal 23 encloses connecting bolt 17 and is positioned between connecting bolt 17 and the inner side of housing 21. Heating element seal 23 seals the interior of the heating element from environmental influences, especially from ambient air, so that coils 5, 13 do not corrode.

Housing 21 is sealed by a housing seal 25. An insulation disk 27 is disposed between circular plug 15 and housing seal 25 enclosing connecting bolt 17. Insulation disk 27 centers the rear part of connecting bolt 17 inside housing and insulates the positive electric terminal from housing 21, which constitutes the negative terminal.

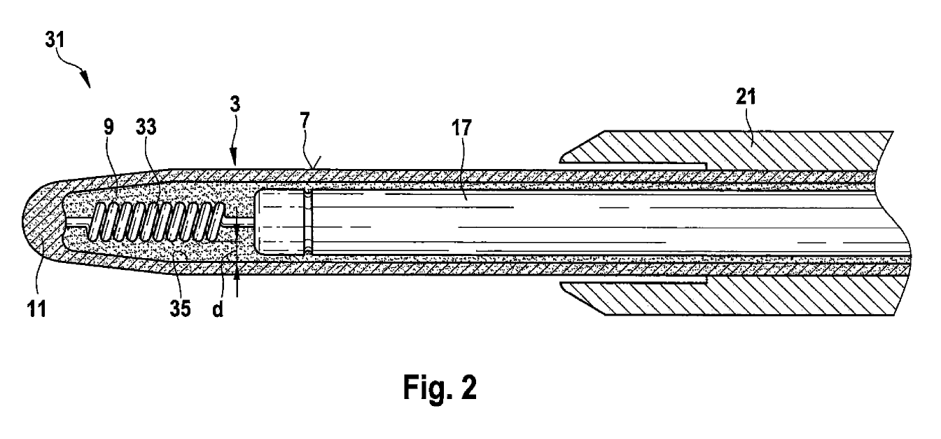

FIG. 2 shows a schematic sectional view of the front part of a sheathed-element glow plug.

Sheathed-element glow plug 31 designed according to the present invention differs from sheathed-element glow plug 1 known from the related art as illustrated in FIG. 1 in that a glow filament 33 is used in place of heating coil 5 and control coil 13 as known from the related art. Glow filament 33 has a specific electric cold resistance of between 0.2 to 1.0 μΩm, which, however, increases with rising temperature. The following applies to the specific electric resistance of the glow filament:

p(T)=pₒ·(1+α·(T−T₀))

p(T) being the specific resistance as a function of temperature T, p₀ being the specific cold resistance at a specific temperature T₀ and α=m/p₀ with a rise m>0.2 μΩm/° C. in the range between 800° C. and 1200° C. Temperature T° usually amounts to 20° C.

According to the present invention, glow filament 33 is disposed only in the front part of glow tube 3. The length of the region in the glow tube inside which glow filament 33 is situated lies in a range of between 5 and 15 mm in this case. To allow sheathed-element glow plug 31 to be operated, glow filament 33 is connected to top 11 of glow tube 3 on the ground side. The other side of glow filament 33 is contacted with connecting bolt 17. Connecting bolt 17, like in sheathed-element glow plug 1 known from the related art and shown in FIG. 1, is connected to a circular plug, via which sheathed-element glow plug 31 is supplied with current.

Suitable materials for glow filament 33 are, for example, NiFe compounds, in particular NiFe30, FeNiCo compounds. Also suitable are high and low alloy steels. Furthermore, it is also possible to design glow filament 33 in such a way that heating coil and control coil components are connected in series in alternation across the length of glow filament 33. To this end, 1 to 3 bonds in each case are made of a heat-conducting material, and adjacent thereto, 1 to 3 bonds are made from a material that is suitable for control coils. This alternate design repeats until the length of glow filament 33 has been reached. Suitable materials in this context are the same as those known for heating coils or control coils from the related art.

In order to achieve the smallest possible temperature gradient between glow filament 33 and surface 7 of glow tube 3, it is preferred if distance d between glow filament 33 and inner side 35 of glow tube 3 is small, if possible, i.e., lies within a range of between 0.2 and 0.6 mm. Glow tube 3 is filled with filler 9, as in the case of the sheathed element glow plug known from the related art and shown in FIG. 1. Here, too, filler 9 preferably is a temperature-stable powder having excellent thermal conduction, usually magnesium oxide powder.

The further design of sheathed-element glow plug 31 including connecting bolt 17, heating element seal 23, housing 21, housing seal 25, insulation disk 27, and circular plug 15 corresponds to the design of sheathed-element glow plug 1 known from the related art and shown in FIG. 1.

The sheathed-element glow plug designed according to the present invention and including glow filament 33, which is disposed in the front region of glow tube 3, makes it possible to detect the temperature of sheathed-element glow plug 31. This is accomplished by detecting the resistance of glow filament 33 during operation of sheathed-element glow plug 31. The resistance is detected with the aid of the means for control of the sheathed-element glow plug, in general a glow control device. Production fluctuations of glow filament 33 may be corrected in that, for example, the glow control device also detects the cold resistance of sheathed-element glow plug 31 and is thus able to calibrate itself to the particular sheathed-element glow plug whose temperature is to be detected. The glow control device preferably also includes a temperature regulator. In this way it is possible to transmit from the engine control device only the temperature required at the sheathed-element glow plug, which is then set by the glow control device. In addition, it is also possible to intercept impermissible setpoint temperatures within the glow control device. Instead of the impermissible setpoint temperatures, especially setpoint temperatures above the permitted maximum temperature, the permitted maximum temperature is then adjusted by the glow control device. The continuous temperature detection and correction to the permitted maximum temperature prevents overheating of sheathed-element glow plug 31 and its possible malfunction due to overheating. In particular, it avoids that sheathed-element glow plug 31 melts at least partially and that parts of sheathed-element glow plug 31 drop into the combustion chamber of the internal combustion engine. This prevents engine damage due to malfunction of sheathed-element glow plug 31.

Because of the temperature detection of sheathed-element glow plug 31 with the aid of the resistance of glow filament 33, permanent detection of the temperature with the aid of the glow control device is possible. If the temperature detection is carried out with sufficient accuracy, then the temperature of sheathed-element glow plug 31 may also be regulated via the glow control device. In this way it is always possible to set the temperature required for the current operating state of the internal combustion engine at sheathed-element glow plug 31. Furthermore, aging effects are able to be compensated. This is achieved in that, for instance, lower temperatures occurring due to aging effects are compensated for by a higher voltage. In addition, driving states that until now could lead to overheating of sheathed-element glow plug 31 and were overlooked in the application phase, for example, do not pose a risk since the temperature is able to be properly adjusted by the glow control device. This simplifies the application of the glow system considerably. In particular, it is no longer necessary to use a measuring-sheathed-element glow plug for the application, which must be produced by hand in a labor-intensive process and has a correspondingly high price. More specifically, it is possible to install sheathed-element glow plug 31 designed according to the present invention into any cylinder of the internal combustion engine, so that temperature monitoring is also able to take place in each cylinder of the internal combustion engine. When using independent means for the control, i.e., an autonomous glow control device, it is possible to limit the closed-loop control to the glow control device and sheathed-element glow plug 31. The closed-loop control thus is no longer dependent upon other electronic components of the motor vehicle.

If a closed-loop control of the temperature of sheathed-element glow plug 31 should not be possible because of a lack of precision in the temperature measurement, the system including the sheathed-element glow plug and glow control device nevertheless may be designed such that monitoring, in which sheathed-element glow plug 31 is switched off once it reaches or exceeds a critical temperature or a critical limit resistance of glow filament 33, is carried out.

What is claimed is:

1. A sheathed-element glow plug comprising:
a glow element having a tip for projecting into a combustion chamber of an internal combustion engine, the glow element including a glow tube; and
a glow filament situated inside the glow tube, which has a specific electric cold resistance in a range of 0.2 to 1.0 μΩm, the specific electric resistance increasing with rising temperature.

2. The sheathed-element glow plug according to claim 1, wherein the glow plug is for starting a self-igniting internal combustion engine.

3. The sheathed-element glow plug according to claim 1, wherein the following applies to the specific electric resistance of the glow filament:
p(T)=pₒ·(1+α·(T−T₀)),
p(T) being the specific resistance as a function of temperature T, p₀ being the specific cold resistance at a specific temperature T₀ and α=m/p₀ with a rise m>0.2 μΩm/° C. in the range between 800° C. and 1200° C.

4. The sheathed-element glow plug according to claim 1, wherein the glow filament is situated in a region 5 to 15 mm from the tip of the glow element.

5. The sheathed-element glow plug according to claim 1, wherein a clearance between the glow filament and an inner side of the glow tube amounts to at least 0.2 mm.

6. The sheathed-element glow plug according to claim 1, wherein the glow filament is connected to a device for detecting a resistance of the glow filament.

7. A device for detecting a temperature of a sheathed-element glow plug including a glow element and a glow filament, the device comprising:
a controller connected to the glow filament for detecting a resistance of the glow filament during operation.

8. The device according to claim 7, wherein the controller includes a closed-loop temperature control.

9. A method for detecting a temperature of a sheathed-element glow plug, the sheathed-element glow plug including a glow element, which has a tip that projects into a combustion chamber of an internal combustion engine, the glow element including a glow tube, the glow plug further including a glow filament situated inside the glow tube, the method comprising:
detecting, using a controller, a resistance of the glow filament during operation; and
determining a temperature at a tip of the glow tube as a function of the resistance.

10. The method according to claim 9, wherein the glow plug is for starting a self-igniting internal combustion engine.

11. The method according to claim 9, further comprising determining, using the controller, a cold resistance of the glow filament, to calibrate the sheathed-element glow plug.

12. The method according to claim 9, further comprising intercepting impermissible setpoint temperatures by the controller.

13. The method according to claim 12, further comprising adjusting a specified permitted maximum temperature by the controller in the case of impermissible setpoint temperatures.

14. The method according to claim 9, further comprising switching off the sheathed-element glow plug if a permissible maximum temperature is exceeded.
